(19) United States
(12) Patent Application Publication
(10) Pub. No.: US 2026/0236927 A1
(43) Pub. Date: Aug. 13, 2026

(54) DETECTING FRAUD BEHAVIOUR IN CARD PAYMENTS

(71) Applicant: PAYPAL, INC., San Jose, CA (US)

(72) Inventors: Mario Fernando Sanchez De la Rosa, Sundbyberg (SE); Karthik Venkatarathnam Uppacharla, Skarpnäck (SE)

(21) Appl. No.: 19/181,225

(22) Filed: Apr. 16, 2025

(30) Foreign Application Priority Data
Feb. 11, 2025 (IN) 202541011560

(51) Int. Cl. G06Q 20/40; G06Q 20/32; G06Q 20/34; H04W 12/12

(52) U.S. Cl. CPC G06Q 20/4016; G06Q 20/32; G06Q 20/34; H04W 12/12

(57) ABSTRACT

The disclosure relates to a system for detecting fraud behaviour in card payments, the system comprises a merchant wireless device and a processing circuitry configured to obtain unique identifiers of surrounding wireless devices based on received radio signals at the merchant wireless device, and configured to determine a surrounding wireless device delta data by comparing unique identifiers of the surrounding wireless devices obtained at the first point in time with unique identifiers of the surrounding wireless devices obtained at the second point in time and determine a fraud behaviour likelihood value.

### CROSS REFERENCE TO RELATED APPLICATION

The present invention claims priority to India Patent Application Serial No. 202541011560, filed Feb. 11, 2025, all of which is incorporated herein by reference in its entirety.

### TECHNICAL FIELD

The present disclosure relates to a system for detecting fraud behaviour in card payments, a method for detecting fraud behaviour in card payments and a non-transitory computer readable storage medium having stored thereon instructions for implementing the method. More specifically, the disclosure relates to a system for detecting fraud behaviour in card payments, a method for detecting fraud behaviour in card payments and a non-transitory computer readable storage medium having stored thereon instructions for implementing the method as defined in the introductory parts of the independent claims.

### BACKGROUND ART

Today card payments is becoming more and more popular. In particular contactless payments is common. Contactless payment is a secure and convenient method for making purchases without physically swiping or inserting a payment card. It typically involves a card payment system, that often comprises at least one merchant device such as a Point of Sale, POS, terminal, or e.g. a contactless-enabled card reader terminal connected to the POS terminal.

A card payment without requiring a PIN or signature however enables any person to make the card payment since there is often no verification made that secures that the person making the card payment is the true holder of the payment card or payment device.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 illustrates, by way of example, a merchant wireless device, surrounding wireless devices and a server, according to the first aspect of the disclosure.

FIG. 2a illustrates, by way of example, a merchant wireless device and surrounding wireless devices at a first point in time.

FIG. 2b illustrates, by way of example, a table with unique identifiers of the surrounding wireless devices together with device addresses, public name, RSSI, and time information obtained at the first point in time.

FIG. 3a illustrates, by way of example, a merchant wireless device and surrounding wireless devices at a second point in time.

FIG. 3b illustrates, by way of example a table with unique identifiers of the surrounding wireless devices together with device addresses, public name, RSSI, and time information obtained at the second point in time.

FIG. 4a illustrates a further example of a merchant wireless device and surrounding wireless devices at a first point in time.

FIG. 4b illustrates a further example of a table with unique identifiers of the surrounding wireless devices together with device addresses, public name, RSSI, and time information obtained at the first point in time.

FIG. 5a illustrates a further example of a merchant wireless device and surrounding wireless devices at a second point in time.

FIG. 5b illustrates a further example of a table with unique identifiers of the surrounding wireless devices together with device addresses, public name, RSSI, and time information obtained at the second point in time.

FIG. 6a illustrates, by way of example, a visualisation of the determinated surrounding wireless device delta data when the change of obtained unique identifiers is high, resulting in a low fraud behaviour likelihood value.

FIG. 6b illustrates, by way of example, a visualisation of the determinated surrounding wireless device delta data when the change of obtained unique identifiers is low, resulting in a high fraud behaviour likelihood value.

FIG. 7 illustrates, by way of example, a flow chart of method steps according to the second aspect of the disclosure.

FIG. 8 illustrates, by way of example, a non-transitory computer readable storage medium according to the third aspect of the disclosure.

FIG. 9 illustrates, by way of example, a flow chart steps over time according to the second aspect of the disclosure.

FIG. 10 illustrates, by way of example, determination of the fraud behaviour likelihood value in view of a predetermined value and setting the fraud behaviour likelihood value and actions according to the fraud behaviour likelihood value.

FIG. 11 illustrates, by way of example, a diagram illustrating a computing system comprising the merchant wireless device, the server, a card reader and a backend payment server

### DETAILED DESCRIPTION

The present disclosure will now be described more fully hereinafter with reference to the accompanying drawings, in which currently preferred embodiments of the invention are shown. This disclosure may, however, be embodied in many different forms.

It is to be understood that the terminology used herein is for purpose of describing particular embodiments only, and is not intended to be limiting. It must be noted that, as used in the specification and the appended claim, the articles “a”, “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary.

Today card payments is becoming more and more popular. In particular contact less card payments is common. Contactless payment is a secure and convenient method for making purchases without physically swiping or inserting a payment card. It typically involves a card payment system, that often comprises at least one merchant device such as a Point of Sale, POS, terminal, or e.g. a contactless-enabled card reader terminal connected to the POS terminal.

A card payment without requiring a PIN or signature however enables any person to make the card payment since there is no verification made that secures that the person making the card payment is the true holder of the payment card or payment device.

To enable contactless payments, the card payment system further comprises software that communicates with a payment backend. Such software is typically installed at the POS terminal.

A contactless payment often uses radio-frequency identification, RFID, or near-field communication, NFC, technology to transmit payment information between the payment card and the card reader terminal. Payment information can also for example be transmitted between a contactless-enabled payment device, such as a smartphone, smartwatch, or other payment device, and the card reader terminal.

The user simply tap or wave the card, or the payment device, near the card reader terminal. The card reader terminal reads the payment information e.g. via RFID or NFC. The transaction is processed, often without needing a PIN or signature for small amounts.

One problem with card payments, such as contact less card payments, is detecting fraudulent payments, e.g. if a card payment system is set up by a person with a criminal intention to e.g. use stolen cards to make card payments with the stolen cards.

There is a desire and a need for an improved way of identifying possible fraudulent behaviour.

It is an object of the present disclosure to mitigate, alleviate or eliminate one or more of the above-identified deficiencies and disadvantages in the prior art and solve at least the above mentioned problem.

According to a first aspect there is provided a system for detecting fraud behaviour in card payments. The system comprises a merchant wireless device configured to receive radio signals to determine presence of surrounding wireless devices and a processing circuitry operatively connected to the merchant wireless device. The processing circuitry is configured to obtain unique identifiers of surrounding wireless devices based on received radio signals at the merchant wireless device, and in a determination of a first triggering event at a first point in time, store the unique identifiers of each surrounding wireless device obtained at the first point in time, and in a determination of a second triggering event at a second point in time, store the unique identifiers of each surrounding wireless device obtained at the second point in time. The processing circuitry is further configured to determine a surrounding wireless device delta data by comparing the unique identifiers of the surrounding wireless devices obtained at the first point in time with the unique identifiers of the surrounding wireless devices obtained at the second point in time. The processing circuitry is further configured to determine a fraud behaviour likelihood value based on the surrounding wireless device delta data.

According to a second aspect there is provided a method for detecting fraud behaviour in card payments. The method comprises the step of obtaining unique identifiers of surrounding wireless devices based on received radio signals at a merchant wireless device, and in a determination of a first triggering event at a first point in time, storing the unique identifiers of each surrounding wireless device obtained at the first point in time, and in a determination of a second triggering event at a second point in time, storing the unique identifiers of each surrounding wireless device obtained at the second point in time. The method further comprises the step of determining a surrounding wireless device delta data by comparing the unique identifiers of the surrounding wireless devices obtained at the first point in time with the unique identifiers of the surrounding wireless devices obtained at the second point in time. The method further comprises the step of determining a fraud behaviour likelihood value based on the surrounding wireless device delta data.

According to a third aspect there is provided a transitory computer readable storage medium having stored thereon instructions for implementing the method according to the second aspect, when executed on a device having processing capabilities.

The present description provides an improved system for detecting fraud behaviour in card payments, method for detecting fraud behaviour in card payments and non-transitory computer readable storage medium having stored thereon instructions for implementing the method.

According to an example embodiment there is provided a system for detecting fraud behaviour in card payments. The system comprises a merchant wireless device configured to receive radio signals to determine presence of surrounding wireless devices. The system further comprises a processing circuitry operatively connected to the merchant wireless device and configured to obtain unique identifiers of surrounding wireless devices based on the received radio signals at the merchant wireless device, and in a determination of a first triggering event at a first point in time, store the unique identifiers of each surrounding wireless device obtained at the first point in time, and in a determination of a second triggering event at a second point in time, store the unique identifiers of each surrounding wireless device obtained at the second point in time. The processing circuitry is further configured to determine a surrounding wireless device delta data by comparing the unique identifiers of the surrounding wireless devices obtained at the first point in time with the unique identifiers of the surrounding wireless devices obtained at the second point in time, and determine a fraud behaviour likelihood value based on the surrounding wireless device delta data.

An advantage with this example embodiment is that fraud behaviour can be detected by determining to what extent the surrounding wireless devices change over time. It is more likely that a potential fraud attempt occurs when there is little or no change of the surrounding wireless devices change over time while it is less likely that a potential fraud attempt occurs when there is a significant change of the surrounding wireless devices change over time, i.e. that new devices are entering and leaving the place where the merchant wireless device is located.

According to an example, the processing circuitry is further configured to continuously obtain unique identifiers of surrounding wireless devices based on the received radio signals at the merchant wireless device and in a determination of a third triggering event at a third point in time, store the unique identifiers of each surrounding wireless device obtained at the third point in time, and determine an updated surrounding wireless device delta data by comparing the unique identifiers of the surrounding wireless devices obtained at the first point in time and the unique identifiers of the surrounding wireless devices obtained at the second point in time with the unique identifiers of the surrounding wireless devices obtained at the third point in time.

By this example, the system advantageously enhances the determination of a potential fraud attempt by further determination to what extent the surrounding wireless devices change over time.

According to an example the first triggering event is caused by a first card payment event, and the second triggering event is caused by a second card payment event.

The system advantageously make use of the fact that when a card payment occurs, e.g. when a user tap or wave the card, or the payment device, near a card reader terminal, to take a snapshot of what surrounding wireless devices that are around the merchant wireless device when the first card payment occurs, and then compare this snapshot with a later snapshot of what surrounding wireless devices that are around the merchant wireless device when the second card payment occurs.

According to an example, the first triggering event is a caused by a timer set to trig an event at a first predetermined time, and the second triggering event is a caused by a timer set to trig an event at a second predetermined time.

The system advantageously make use of the predetermined times, to take a snapshot of what surrounding wireless devices that are around the merchant wireless device at the first predetermined time, and then compare this snapshot with a later snapshot of what surrounding wireless devices that are around the merchant wireless device at the second point in time.

According to an example, the fraud behaviour likelihood value is based on the change of obtained unique identifiers of surrounding wireless devices over time.

By this example, the system advantageously determines a potential fraud attempt by plural determinations to what extent the surrounding wireless devices change over time.

According to an example, the fraud behaviour likelihood value is further based on behaviour analysis and/or pattern analysis of meta data, wherein the meta data is at least any of frequency of transaction data, transaction time data, merchant category code data, transaction parameter data, merchant market data, time of day data, location information data, wide area wireless communication network data, and surrounding temperature data.

The system advantageously use the meta data to further further enhance the determination of a potential fraud attempt.

According to an example, the fraud behaviour likelihood value is based the change of obtained unique identifiers of surrounding wireless devices over time and in a determination that the change of obtained unique identifiers of surrounding wireless devices over time is below a predetermined value, set a high fraud behaviour likelihood value, and in a determination that the change of obtained unique identifiers of surrounding wireless devices over time is above the predetermined value, set a low fraud behaviour likelihood value.

The system advantageously use the predetermined value to quantify when a potential fraud attempt occurs.

According to an example embodiment there is provided a method for detecting fraud behaviour in card payments. The method comprises the step of obtaining unique identifiers of surrounding wireless devices based on received radio signals at a merchant wireless device, and in a determination of a first triggering event at a first point in time, storing the unique identifiers of each surrounding wireless device obtained at the first point in time, and in a determination of a second triggering event at a second point in time, storing the unique identifiers of each surrounding wireless device obtained at the second point in time. The method further comprises the step of determining a surrounding wireless device delta data by comparing the unique identifiers of the surrounding wireless devices obtained at the first point in time with the unique identifiers of the surrounding wireless devices obtained at the second point in time, and the step of determining a fraud behaviour likelihood value based on the surrounding wireless device delta data.

An advantage with this example embodiment is that fraud behaviour can be detected by determining to what extent the surrounding wireless devices change over time. It is more likely that a potential fraud attempt occurs when there is little or no change of the surrounding wireless devices change over time while it is less likely that a potential fraud attempt occurs when there is a significant change of the surrounding wireless devices change over time, i.e. that new devices are entering and leaving the place where the merchant wireless device is located.

According to an example, the method further comprises the step of that in a determination of a third triggering event at a third point in time, storing the unique identifiers of each surrounding wireless device obtained at the third point in time, and the step of determining an updated surrounding wireless device delta data by comparing the unique identifiers of the surrounding wireless devices obtained at the first point in time and the unique identifiers of the surrounding wireless devices obtained at the second point in time with the unique of the surrounding wireless devices obtained at the third point in time.

By this example, the method advantageously enhances the determination of a potential fraud attempt by the further determination to what extent the surrounding wireless devices change over time.

According to an example, wherein the first triggering event is caused by a first card payment event, and the second triggering event is caused by a second card payment event.

The method advantageously make use of the fact that when a card payment occurs, e.g. when a user tap or wave the card, or the payment device, near a card reader terminal, to take a snapshot of what surrounding wireless devices that are around the merchant wireless device when the first card payment occurs, and then compare this snapshot with a later snapshot of what surrounding wireless devices that are around the merchant wireless device when the second card payment occurs.

According to an example, wherein the first triggering event is a caused by a timer set to trig an event at a first predetermined time, and the second triggering event is a caused by a timer set to trig an event at a second predetermined time.

The method advantageously make use of the predetermined times, to take a snapshot of what surrounding wireless devices that are around the merchant wireless device at the first predetermined time, and then compare this snapshot with a later snapshot of what surrounding wireless devices that are around the merchant wireless device at the second point in time.

According to an example, wherein the fraud behaviour likelihood value is based on the change of obtained unique identifiers of surrounding wireless devices over time.

By this example, the method advantageously determines a potential fraud attempt by plural determinations to what extent the surrounding wireless devices change over time.

According to an example, the fraud behaviour likelihood value is based the change of obtained unique identifiers of surrounding wireless devices over time and in a determination that the change of obtained unique identifiers of surrounding wireless devices over time is below a predetermined value, setting a high fraud behaviour likelihood value, and in a determination that the change of obtained unique identifiers of surrounding wireless devices over time is above the predetermined value, setting a low fraud behaviour likelihood value.

The method advantageously use the predetermined value to quantify when a potential fraud attempt occurs.

According to an example, the method further comprises the step of determining a fraud behaviour likelihood value that is above a predetermined threshold value, and terminating further card payment events.

The method advantageously use of the fact that when the fraud behaviour likelihood value is above a predetermined threshold value, it has been defined that a potential fraud attempt occurs, and uses this fact to terminate further card payments.

According to an example, the method further comprises the step of obtaining metadata associated with each unique identifier, and the step of determining a fraud behaviour likelihood value based on the wireless device delta data and the metadata associated with each unique identifier.

The method advantageously use the meta data to further enhance the determination of a potential fraud attempt.

According to an example, the method further comprises the step of determining a static surrounding wireless device based on the surrounding wireless device delta data in that the unique identifier of the static surrounding wireless device is always present at plural points in time, and the step of excluding the static surrounding wireless device in further determination of the surrounding wireless device delta data.

The method advantageously use the knowledge of the static surrounding wireless device to carve out that device from the snapshots when determining the surrounding wireless device delta data.

According to an example, the method comprises the step of determining a relative distance between the merchant wireless device and each surrounding wireless device based on a received signal strength indicator of the received radio signals at the merchant wireless device, and the step of determining a fraud behaviour likelihood value based on the surrounding wireless device delta data and the relative distance between the merchant wireless device and each surrounding wireless device.

The method advantageously use the information of the received signal strength indicator of the surrounding wireless devices for enhancing the determination of the surrounding wireless device delta data.

According to an example embodiment there is provided a computer readable storage medium having stored thereon instructions for implementing the method according to the second aspect, when executed on a device having processing capabilities.

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

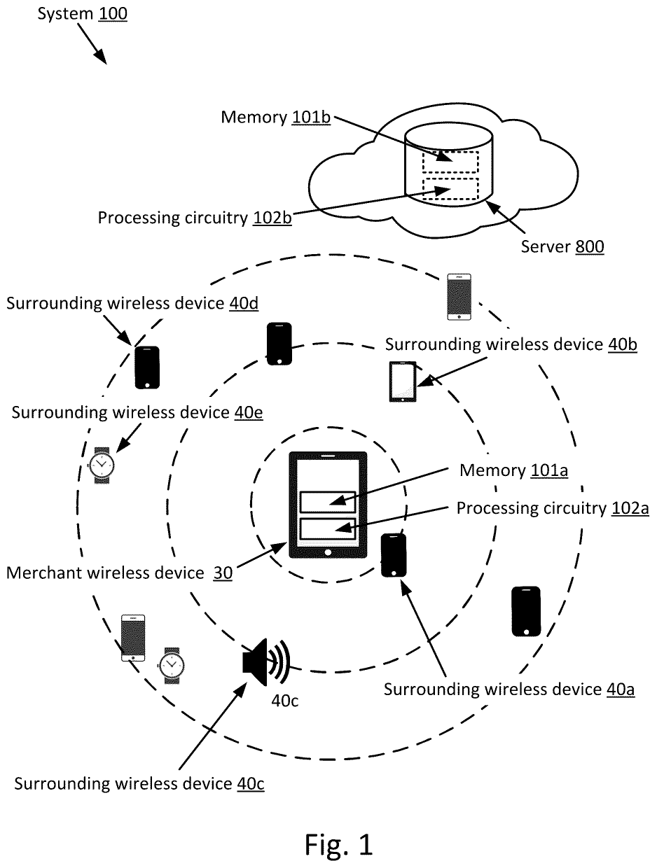

FIG. 1 illustrates, by way of example, a merchant wireless device, surrounding wireless devices and a server, according to the first aspect of the disclosure.

The first aspect of this disclosure shows a system 100 for detecting fraud behaviour in card payments. According to some embodiments the card payment is a contactless card payment. According to some embodiments the card payment is a digital wallet payment. In an example the contactless card payment is using a tokenized card in the digital wallet. According to some embodiments the digital wallet is any of a e-wallet or a mobile wallet. In an example embodiment the contactless card payment is performed by presenting any of a contactless card or a device with a digital wallet close to a card reader terminal.

According to some embodiments the card payment is an electronic payment. In an example embodiment the card payment is performed by swiping or inserting a physical card in a card reader terminal. In an example the physical card uses a chip and/or a magstripe. The system 100 comprises a merchant wireless device 30. The merchant wireless device 30 is configured to receive radio signals. The merchant wireless device 30 may be any wireless device, such as a a smartphone, a tablet, a smartwatch, a personal computer, a laptop, a card payment system device, a POS terminal, a card reader terminal, a cash register device. In FIG. 1 the merchant wireless device 30 is illustrated as a tablet.

The merchant wireless device 30 may be connected to a card reader terminal, or have an integrated card reader. The merchant wireless device 30 may run a software application for card payments. Typically, the merchant wireless device 30 is used by a merchant at a location such as a coffee shop, a store, a restaurant, a market place, to facilitate card payments.

The merchant wireless device 30 is configured to receive radio signals to determine presence of surrounding wireless devices 40a,40b,40c,40d,40e, . . . ,40n.

The surrounding wireless devices 40a,40b,40c,40d,40e, . . . ,40n may be any wireless device, such as a a smartphone, a tablet, a smartwatch, a personal computer, and a laptop. Typically the surrounding wireless devices 40a,40b,40c,40d,40e, . . . ,40n are worn or used by users that are at the premises of the merchant. In an example, people that are in a store wear or use at least one surrounding wireless device. In FIG. 1, the surrounding wireless device 40a and 40d are illustrated as smartphones, the surrounding wireless device 40b is illustrated as a tablet, the surrounding wireless device 40c is illustrated as loudspeaker, and the surrounding wireless device 40e is illustrated as a smartwatch.

The system 100 further comprises a processing circuitry 102a,102b. In FIG. 1 the processing circuitry 102a is the processing circuitry of the merchant wireless device 30. In FIG. 1 the processing circuitry 102b is the processing circuitry of a server 800.

The processing circuitry 102a,102b is operatively connected to the merchant wireless device 30. The processing circuitry 102a,102b may be operatively connected to the merchant wireless device 30 via a wired or a wireless connection.

In the example illustration in FIG. 1 the processing circuitry 102a integrated in the merchant wireless device 30, and operatively connected via a wired connection.

In the example illustration in FIG. 1 the processing circuitry 102b of the server 800 is operatively connected to the merchant wireless device 30 via a wireless connection.

The wireless connection may be enabled via a local area wireless communication network. The wireless connection may be a standardized wireless local area network such as a Wireless Local Area Network, WLAN, Bluetooth™, ZigBee, Ultra-Wideband, Near Field Communication, NFC, Radio Frequency Identification, RFID, or similar network.

The wireless connection may be enabled via a wide area wireless communication network. The wireless connection may be a standardized wide area wireless communication network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network.

The system 100 may comprise a memory 101a,101b configured to store data. In FIG. 1 the memory 101a is the memory of the merchant wireless device 30. In FIG. 1 the memory 101b is the memory of a server 800.

The memory 101a,101b may be operatively connected to the processing circuitry 102a,102b. The memory 101a,101b may be operatively connected to the processing circuitry 102a,102b via a wired or a wireless connection.

The processing circuitry 102a,102b is configured to obtain unique identifiers ID1,ID2,ID3,ID4,ID5, . . . ,IDn of surrounding wireless devices 40a,40b,40c,40d,40e, . . . ,40n based on the received radio signals at the merchant wireless device 30.

The unique identifier ID1,ID2,ID3,ID4,ID5, . . . ,IDn of each surrounding wireless device 40a,40b,40c,40d,40e, . . . ,40n may be a medium access control address, MAC address, that is a unique identifier assigned to the surrounding wireless device for use as a network address in communication with other devices. For example, Bluetooth and Wireless Local Area Network technologies support sending MAC addresses via radio signals.

In one example, the unique identifier ID1,ID2,ID3,ID4,ID5, . . . ,IDn of each surrounding wireless device 40a,40b,40c,40d,40e, . . . ,40n may be at least any of a universally unique identifier, a manufacturer-specific data that contain a unique serial or model information and a service data that includes device-specific data.

The unique identifiers ID1,ID2,ID3,ID4,ID5, . . . ,IDn of surrounding wireless devices 40a,40b,40c,40d,40e, . . . ,40n may be constantly broadcasted, or frequently transmitted, via radio signals by the surrounding wireless devices 40a,40b,40c,40d,40e, . . . ,40n. The unique identifiers ID1,ID2,ID3,ID4,ID5, . . . ,IDn may for example be a Bluetooth MAC address or a WiFi MAC address.

The processing circuitry 102a,102b is configured to obtain the unique identifiers ID1,ID2,ID3,ID4,ID5, . . . ,IDn of surrounding wireless devices 40a,40b,40c,40d,40e, . . . ,40n based on the received radio signals at the merchant wireless device 30, and in a determination of a first triggering event at a first point in time, store the unique identifiers ID1,ID2,ID3,ID4,ID5, . . . ,IDn of each surrounding wireless device 40a,40b,40c,40d,40e, . . . ,40n obtained at the first point in time, and in a determination of a second triggering event at a second point in time, store the unique identifiers of each surrounding wireless device obtained at the second point in time.

In an example the unique identifiers ID1,ID2,ID3,ID4,ID5 are stored in the memory 101a, 101b.

In other words, one can say that a “snapshot” of what surrounding wireless devices that are around the merchant wireless device at the first point in time is stored, and then later another “snapshot” of what surrounding wireless devices that are around the merchant wireless device at the second point in time is stored.

The processing circuitry 102a,102b is then configured to determine a surrounding wireless device delta data swddd by comparing the unique identifiers ID1,ID2,ID3,ID4,ID5, . . . ,IDn of the surrounding wireless devices 40a,40b,40c,40d,40e, . . . ,40n obtained at the first point in time with the unique identifiers of the surrounding wireless devices obtained at the second point in time, and determine a fraud behaviour likelihood value fraud-v based on the surrounding wireless device delta data swddd.

An advantage with this first aspect is that fraud behaviour can be detected by determining to what extent the surrounding wireless devices change over time. It is more likely that a potential fraud attempt occurs when there is little or no change of the surrounding wireless devices change over time while it is less likely that a potential fraud attempt occurs when there is a significant change of the surrounding wireless devices change over time, i.e. that new devices are entering and leaving the place where the merchant wireless device is located.

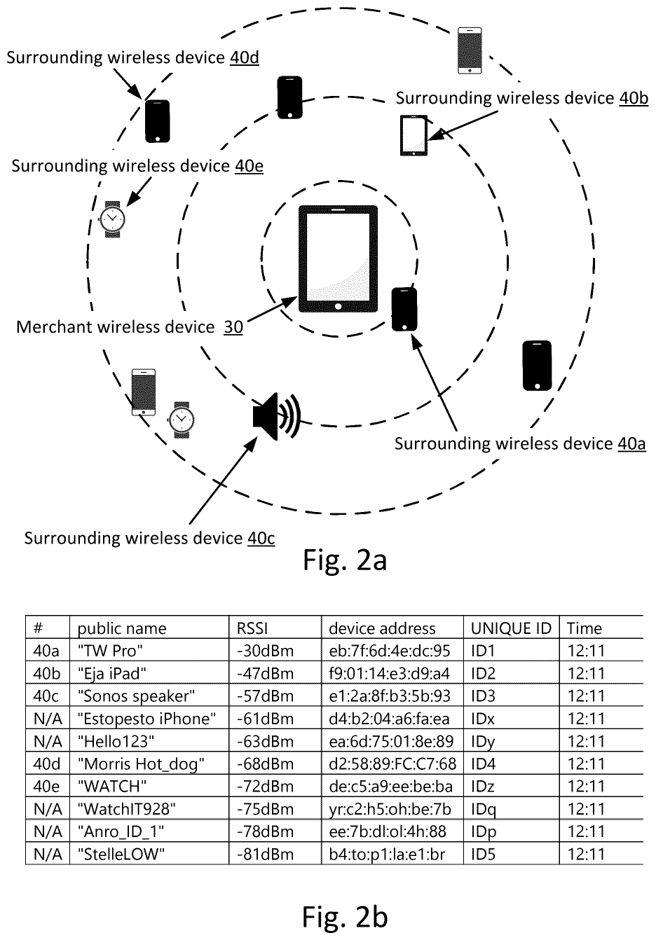

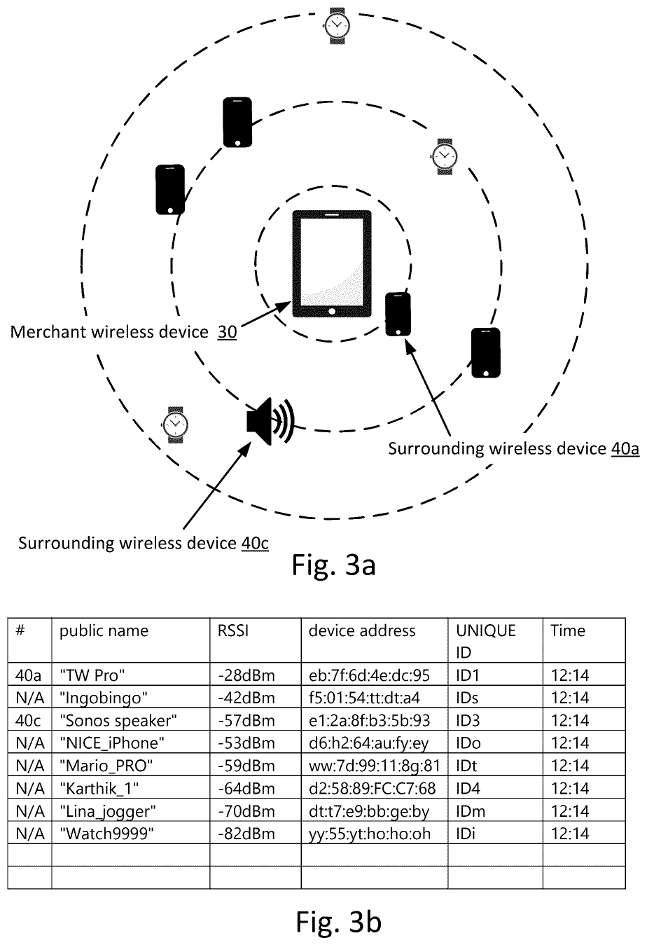

Reference is now made to the FIGS. 2a, 2b, 3a and 3b. FIG. 2a illustrates, by way of example, a merchant wireless device 30 and surrounding wireless devices 40a,40b,40c,40d,40e, . . . ,40n at a first point in time. In FIG. 2 surrounding wireless device 40a and 40d are illustrated as smartphones, the surrounding wireless device 40b is illustrated as a tablet, the surrounding wireless device 40c is illustrated as loudspeaker, and the surrounding wireless device 40e is illustrated as a smartwatch. By way of example, the merchant wireless device 30 is placed at a counter in a store, and is used for facilitating card payments. Typically in a store, the merchant can register the goods or services to be purchased at the merchant wireless device 30, and the merchant wireless device 30 can be connected to a card reader terminal, to facilitate an card payment.

FIG. 2b illustrates, by way of example, a table with unique identifiers of the surrounding wireless devices 40a,40b,40c,40d,40e, . . . ,40n together with device addresses, public name, RSSI, and time information obtained at the first point in time. In particular, FIG. 2b illustrates the unique identifiers ID1,ID2,ID3,ID4,ID5, . . . ,IDn of the surrounding wireless devices 40a,40b,40c,40d,40e, . . . ,40n obtained at the first point in time. In the example table in FIG. 2b the unique identifiers are exemplified as MAC addresses e.g. “eb:7f:6d:4e:dc:95” assigned as Unique ID “ID1” listed together with a public name “TW Pro”, and there is also information about when, what time “12:11”, the snapshot was obtained and information about the received signal strength indicator, RSSI, value e.g. “−30 dBm”

Turing to FIG. 3a, that illustrates, by way of example, the merchant wireless device 30 and the surrounding wireless devices at a second point in time. FIG. 3b illustrates, by way of example a table with the unique identifiers of the surrounding wireless devices together with device addresses, public name, RSSI, and time information obtained at the second point in time when the second snapshot was obtained, at “12:14”. FIG. 3a and FIG. 3b illustrates that it is only the surrounding wireless devices 40a the “TW Pro” and 40c the “Sonos speaker” that are the same devices when comparing the second snapshot with first snapshot. The other surrounding wireless devices are new. Hence there has been a significant change of the surrounding wireless devices change over time, i.e. that new devices are entering and leaving the place where the merchant wireless device 30 is located.

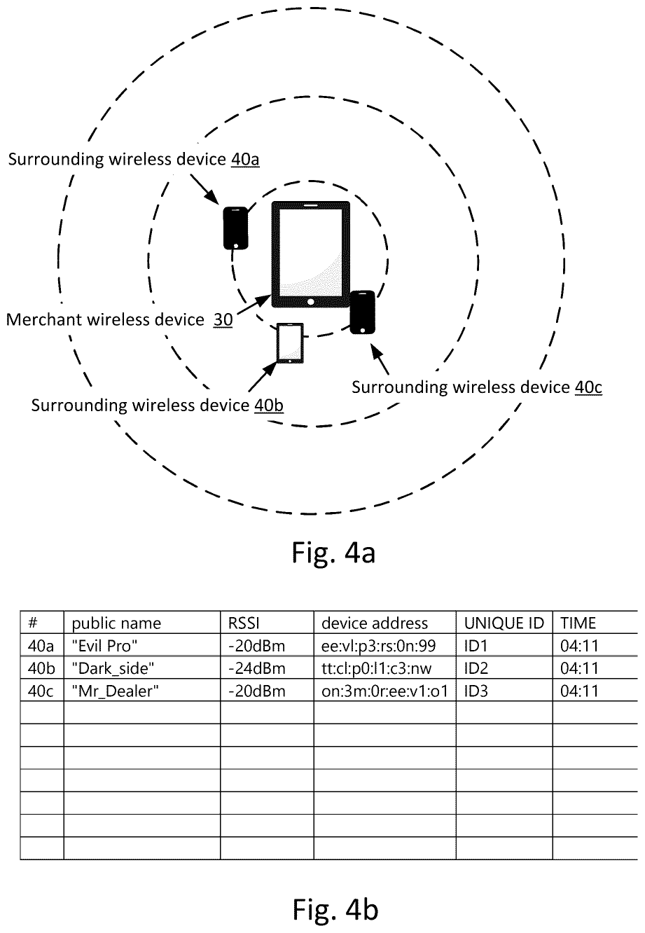

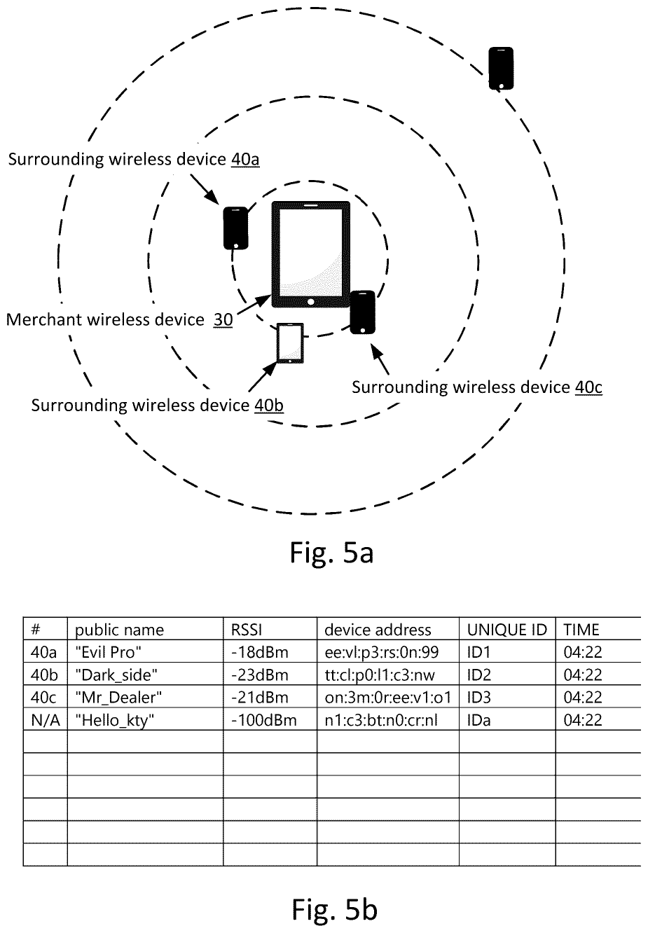

Turing to FIGS. 4a, 4b, 5a and 5b. FIG. 4a illustrates a further example of a merchant wireless device 30 and surrounding wireless devices at a first point in time. FIG. 4b illustrates a table with unique identifiers of the surrounding wireless devices together with device addresses, public name, RSSI, and time information obtained at the first point in time, in the snapshot obtained “04:11”, in this further example.

FIG. 5a illustrates this further example of the merchant wireless device 30 and surrounding wireless devices at a second point in time. FIG. 5b illustrates the table with unique identifiers of the surrounding wireless devices together with device addresses, public name, RSSI, and time information obtained at the second point in time, in the snapshot obtained “04:22”, in this further example.

FIG. 3a and FIG. 3b illustrates that same surrounding wireless devices “Evil Pro”, “Dark_side” and “Mr_Dealer” occurs both in the first snapshot and the second snapshot. It is only one device, “Hello_kty”, that is new in the snapshot obtained “04:22”.

Hence there has been not been a significant change of the surrounding wireless devices change over time. It is more likely that a potential fraud attempt occurs when there is little or no change of the surrounding wireless devices change over time.

The wireless device delta data, swddd, is determined by comparing the unique identifiers of the surrounding wireless devices obtained at the first point in time with the unique identifiers of the surrounding wireless devices obtained at the second point in time and the fraud behaviour likelihood value, fraud-v, is determined based on the surrounding wireless device delta data, swddd.

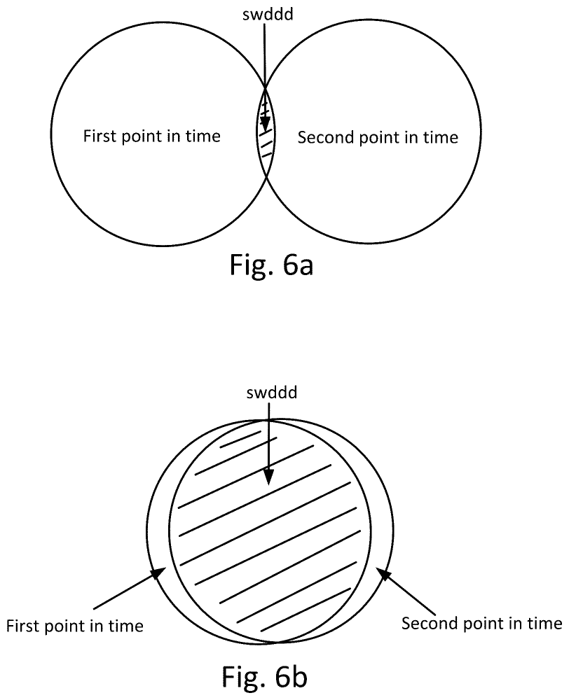

With respect to determining wireless device delta data, swddd, and the fraud behaviour likelihood value, fraud-v, reference is made to FIGS. 6a and 6b.

FIG. 6a illustrates, by way of example, a visualisation of the determinated surrounding wireless device delta data when the change of obtained unique identifiers is high, resulting in a low fraud behaviour likelihood value. In this example, there is a significant change of the surrounding wireless devices change over time, when comparing the comparing the unique identifiers of the surrounding wireless devices obtained at the first point in time with the unique identifiers of the surrounding wireless devices obtained at the second point in time.

FIG. 6b illustrates, by way of example, a visualisation of the determinated surrounding wireless device delta data when the change of obtained unique identifiers is low, i.e when there is little or no change of the surrounding wireless devices change over time, resulting in a high fraud behaviour likelihood value.

In one example the wireless device delta data, swddd, is correlated with the the fraud behaviour likelihood value, fraud-v. In one example the wireless device delta data, swddd gives and indication of the change of the surrounding wireless devices change over time conclusions can be drawn to determine the fraud behaviour likelihood value, fraud-v.

According to an example the processing circuitry is further configured to continuously obtain unique identifiers of surrounding wireless devices based on the received radio signals at the merchant wireless device 30 and, in a determination of a third triggering event at a third point in time, store the unique identifiers of each surrounding wireless device obtained at the third point in time, and determine an updated surrounding wireless device delta data swddd by comparing the unique identifiers ID1,ID2,ID3,ID4,ID5, . . . ,IDn of the surrounding wireless devices 40a,40b,40c,40d,40e, . . . ,40n obtained at the first point in time and the unique identifiers of the surrounding wireless devices obtained at the second point in time with the unique identifiers of the surrounding wireless devices obtained at the third point in time.

By this example, the system advantageously enhances the determination of a potential fraud attempt by further determination to what extent the surrounding wireless devices change over time. In an example, comparing the three snapshots gives further data to the determination of the updated surrounding wireless device delta data swddd. In an example the third triggering event is generated by a determination of a fraud behaviour likelihood value fraud-v that is indicative of that a potential fraud attempt occurs, and by the updated surrounding wireless device delta data swddd, the determined fraud behaviour likelihood value fraud-v can be verified.

According to an example the first triggering event is caused by a first card payment event, and the second triggering event is caused by a second card payment event. The system advantageously make use of the fact that when an card payment occurs, e.g. when a user tap or wave the card, or the payment device, near a card reader terminal, to take a snapshot of what surrounding wireless devices that are around the merchant wireless device when the first card payment occurs, and then compare this snapshot with a later snapshot of what surrounding wireless devices that are around the merchant wireless device when the second card payment occurs.

Any card payment event, caused by any user, may trigger the first and second triggering event. In an example different customers causes the different triggering events. In the example as illustrated in FIGS. 2a, 2b, 3a and 3b, the customer of the surrounding wireless device 40a “TW Pro” first buys something causing the first triggering event, and then on the way out of the store three minutes later, the same customer, i.e. the customer of the surrounding wireless device 40a “TW Pro”, notice a further item to buy and makes a further purchase, causing the second triggering event, which is the reason the the surrounding wireless device 40a “TW Pro” is still around.

According to an example the first triggering event is a caused by a timer set to trig an event at a first predetermined time, and the second triggering event is a caused by a timer set to trig an event at a second predetermined time.

The system advantageously make use of the predetermined times, to take a snapshot of what surrounding wireless devices that are around the merchant wireless device at the first predetermined time, and then compare this snapshot with a later snapshot of what surrounding wireless devices that are around the merchant wireless device at the second point in time. In an example, the timer is set to trig an event at a certain frequency, such as every second minute. In an example, the timer is set to trig an event within a certain time period after a certain transaction value has been transferred.

According to an example the fraud behaviour likelihood value fraud-v is based on the change of obtained unique identifiers of surrounding wireless devices over time. By this example, the system advantageously determines a potential fraud attempt by plural determinations to what extent the surrounding wireless devices change over time.

According to an example the fraud behaviour likelihood value fraud-v is further based on behaviour analysis and/or pattern analysis of meta data, wherein the meta data is at least any of frequency of transaction data, transaction time data, merchant category code data, transaction parameter data, merchant market data, time of day data, location information data, wide area wireless communication network data and surrounding temperature data. The system advantageously use the meta data to further enhance the determination of a potential fraud attempt. In an example, the fraud behaviour likelihood value fraud-v is further based on frequency of transaction data e.g. by analysing the number of transactions that occur within a predetermined time period. In an example, the fraud behaviour likelihood value fraud-v is further based on transaction parameter data analysing the value of the transaction amounts over time. In an example, the fraud behaviour likelihood value fraud-v is further based on merchant category code data analysing the use of category codes over time. In an example, the fraud behaviour likelihood value fraud-v is further based on time of day data analysing the time of the day the transaction occurs. In an example, the fraud behaviour likelihood value fraud-v is further based on surrounding temperature data analysing the change of the temperature when transaction occurs.

In an example, the fraud behaviour likelihood value fraud-v is further based on location information data, by analysing the geographical location. In an example, the merchant wireless device 30 has been in one country for a period of time, but then the merchant wireless device 30 seems to be in another country, this may be an indication of a fraud behaviour.

In an example, the fraud behaviour likelihood value fraud-v is further based on meta data shared between plural merchant wireless devices.

In an example, the fraud behaviour likelihood value fraud-v is further based on location information data by analysing the geographical location. In an example, a unique identifier of a surrounding wireless device is obtained by a merchant wireless device in a one country, but the same unique identifier is obtained by a merchant wireless device in another country, this may be an indication of a fraud behaviour.

In an example, the fraud behaviour likelihood value fraud-v is further based on wide area wireless communication network data, by e.g. analysing the identity of the cellular radio base station identification information. In an example, a unique identifier of the cellular radio base station identification information is obtained by a merchant wireless device indicative of a cellular radio base station at a first location, but then a different cellular radio base station identification information is obtained by the merchant wireless device indicative of a cellular radio base station at a second location far away from the first location, this may be an indication of a fraud behaviour.

According to an example the fraud behaviour likelihood value is based the change of obtained unique identifiers of surrounding wireless devices over time and in a determination that the change of obtained unique identifiers of surrounding wireless devices over time is below a predetermined value pdv, set a high fraud behaviour likelihood value high-fraud-v, and in a determination that the change of obtained unique identifiers of surrounding wireless devices over time is above the predetermined value pdv, set a low fraud behaviour likelihood value low-fraud-v.

The system advantageously use the predetermined value to quantify when a potential fraud attempt occurs.

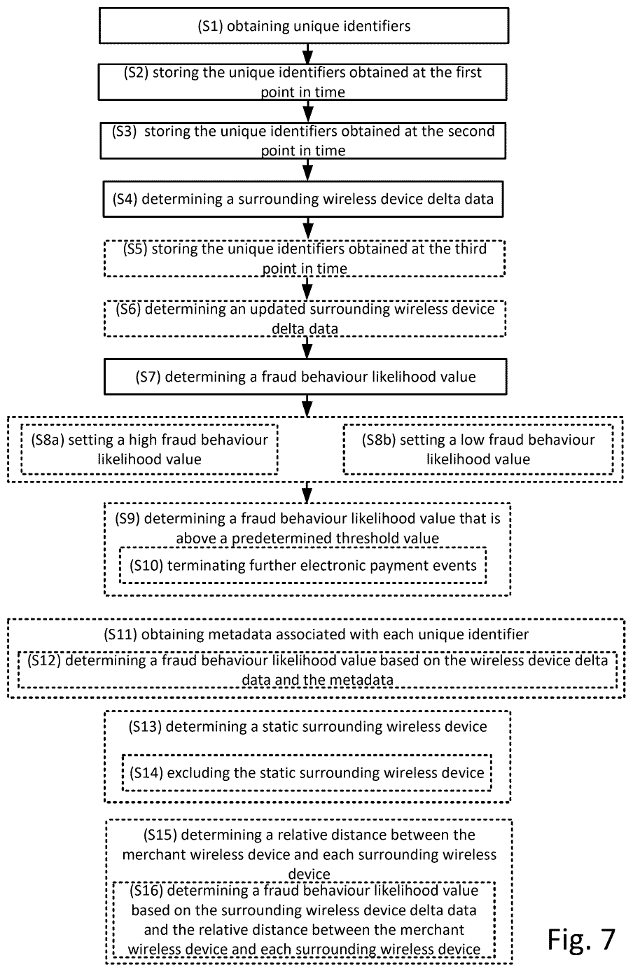

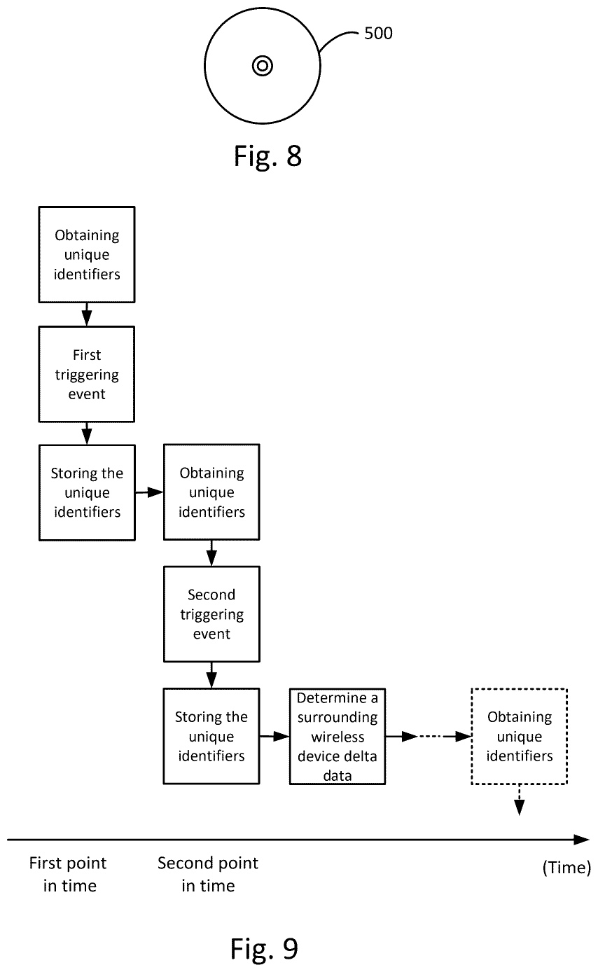

The second aspect of this disclosure shows a method for detecting fraud behaviour in card payments. FIG. 7 illustrates, by way of example, a flow chart of method steps according to the second aspect of the disclosure.

The method comprises the step of S1 obtaining unique identifiers ID1,ID2,ID3,ID4,ID5, . . . ,IDn of surrounding wireless devices 40a,40b,40c,40d,40e, . . . ,40n based on received radio signals at a merchant wireless device 30, and the step of S2 in a determination of a first triggering event at a first point in time, storing the unique identifiers ID1,ID2,ID3,ID4,ID5, . . . ,IDn of each surrounding wireless device 40a,40b,40c,40d,40e obtained at the first point in time, and the step of S3 in a determination of a second triggering event at a second point in time, storing the unique identifiers of each surrounding wireless device obtained at the second point in time. The method further comprises the step of S4 determining a surrounding wireless device delta data swddd by comparing the unique identifiers ID1,ID2,ID3,ID4,ID5, . . . ,IDn of the surrounding wireless devices 40a,40b,40c,40d,40e, . . . ,40n obtained at the first point in time with the unique identifiers of the surrounding wireless devices obtained at the second point in time, and the step of S7 determining a fraud behaviour likelihood value fraud-v based on the surrounding wireless device delta data swddd.

An advantage with this second aspect is that fraud behaviour can be detected by determining to what extent the surrounding wireless devices change over time. It is more likely that a potential fraud attempt occurs when there is little or no change of the surrounding wireless devices change over time while it is less likely that a potential fraud attempt occurs when there is a significant change of the surrounding wireless devices change over time, i.e. that new devices are entering and leaving the place where the merchant wireless device is located.

FIG. 9 illustrates, by way of example, a flow chart steps over time according to the second aspect of the disclosure. In FIG. 9 obtaining unique identifiers and storing them after a first triggering event occurs at a first point in time. This has also been referred to the first snapshot. Further in FIG. 9 obtaining unique identifiers and storing them after a second triggering event occurs at a second point in time. This has also been referred to the second snapshot. After the second point in time follows the determination of the surrounding wireless device delta data. It is also illustrated in FIG. 9 that the method can in one example then continue and start over again and obtain unique identifiers to do further determinations of the surrounding wireless device delta data. In an example this is a continuously ongoing process in order to be constant vigilant in order to possibly determine fraud behaviuor.

According to an example the method further comprises the step of S5 in that in a determination of a third triggering event at a third point in time, storing the unique identifiers of each surrounding wireless device obtained at the third point in time, and the method further comprises the step of S6 determining an updated surrounding wireless device delta data swddd by comparing the unique identifiers ID1,ID2,ID3,ID4,ID5, . . . ,IDn of the surrounding wireless devices 40a,40b,40c,40d,40e, . . . ,40n obtained at the first point in time and the unique identifiers of the surrounding wireless devices obtained at the second point in time with the unique of the surrounding wireless devices obtained at the third point in time. By this example, the method advantageously enhances the determination of a potential fraud attempt by the further determination to what extent the surrounding wireless devices change over time.

According to an example the first triggering event is caused by a first card payment event, and the second triggering event is caused by a second card payment event. The method advantageously make use of the fact that when an card payment occurs, e.g. when a user tap or wave the card, or the payment device, near a card reader terminal, to take a snapshot of what surrounding wireless devices that are around the merchant wireless device when the first card payment occurs, and then compare this snapshot with a later snapshot of what surrounding wireless devices that are around the merchant wireless device when the second card payment occurs.

According to an example the first triggering event is a caused by a timer set to trig an event at a first predetermined time, and the second triggering event is a caused by a timer set to trig an event at a second predetermined time. The method advantageously make use of the predetermined times, to take a snapshot of what surrounding wireless devices that are around the merchant wireless device at the first predetermined time, and then compare this snapshot with a later snapshot of what surrounding wireless devices that are around the merchant wireless device at the second point in time.

According to an example the fraud behaviour likelihood value fraud-v is based on the change of obtained unique identifiers of surrounding wireless devices over time. By this example, the method advantageously determines a potential fraud attempt by plural determinations to what extent the surrounding wireless devices change over time.

According to an example the fraud behaviour likelihood value is based the change of obtained unique identifiers of surrounding wireless devices over time and the method further comprises the step of S8a in a determination that the change of obtained unique identifiers of surrounding wireless devices over time is below a predetermined value pdv, setting a high fraud behaviour likelihood value high-fraud-v, and the step of S8b in a determination that the change of obtained unique identifiers of surrounding wireless devices over time is above the predetermined value pdv, setting a low fraud behaviour likelihood value low-fraud-v.

The method advantageously use the predetermined value to quantify when a potential fraud attempt occurs.

According to an example method further comprises the step of S9 determining a fraud behaviour likelihood value fraud-v that is above a predetermined threshold value, and the step of S10 terminating further card payment events. The method advantageously use of the fact that when the fraud behaviour likelihood value is above a predetermined value, it has been defined that a potential fraud attempt occurs, and uses this fact to terminate further card payments. According to some embodiments when terminating further card payments a card payment service provider enabling the card payment is informed. In an example embodiment, when terminating further card payment events, a report is sent to the card payment service provider with card payment information details.

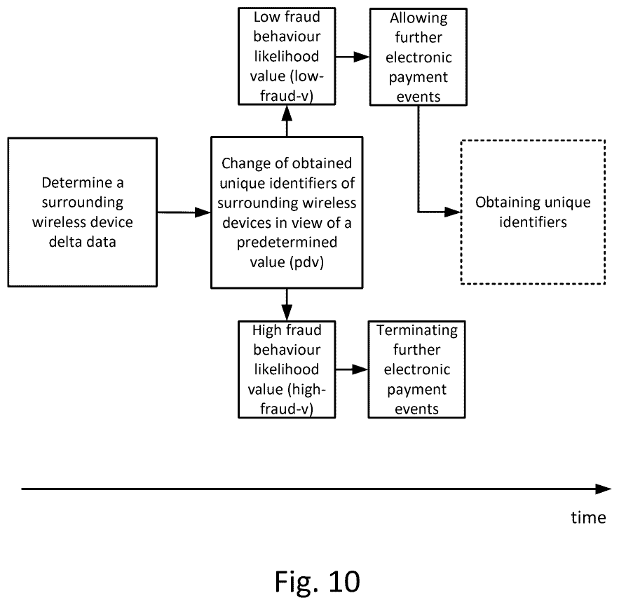

FIG. 10 illustrates, by way of example, determination of the fraud behaviour likelihood value in view of a predetermined value and setting the fraud behaviour likelihood value and actions according to the fraud behaviour likelihood value. In the example a certain predetermined value pdv

According to an example the method further comprises the step of S11 obtaining metadata associated with each unique identifier, and the step of S12 determining a fraud behaviour likelihood value fraud-v based on the wireless device delta data wddd and the metadata associated with each unique identifier. The method advantageously use the meta data to further enhance the determination of a potential fraud attempt.

According to an example the method further comprises the step of S13 determining a static surrounding wireless device based on the surrounding wireless device delta data swddd in that the unique identifier of the static surrounding wireless device is always present at plural points in time, and the step of S14 excluding the static surrounding wireless device in further determination of the surrounding wireless device delta data swddd. The method advantageously use the knowledge of the static surrounding wireless device to carve out that device front the snapshots when determining the surrounding wireless device delta data.

Reference is made to FIGS. 2a, 2b, 3a and 3b. When comparing comparing the unique identifiers ID1, ID2, ID3, ID4, ID5, . . . ,IDn of the surrounding wireless devices 40a, 40b, 40c, 40d, 40e, . . . ,40n obtained at the first point in time, as illustrated in FIGS. 2a and 2b, with the unique identifiers of the surrounding wireless devices obtained at the second point in time, as illustrated in FIGS. 3a and 3b, it becomes obvious that the surrounding wireless device 40c, the “Sonos speaker” is still there with the same unique identifier “e1:2a:8f:b3:5b:93” but also with the same RSSI −57 dBm. In the example the “Sonos speaker” is installed in the shop and will constantly occur when obtaining the unique identifiers, this the surrounding wireless device can be determined to be excluded in further determinations of the surrounding wireless device delta data swddd. In one example the RSSI data is also used for determining if the the surrounding wireless device can be determined to be excluded in further determinations of the surrounding wireless device delta data swddd.

According to an example the method further comprises the step of S15 determining a relative distance between the merchant wireless device 30 and each surrounding wireless device 40a,40b,40c,40d,40e, . . . ,40n based on a received signal strength indicator RSSI of the received radio signals at the merchant wireless device 30, and the step of S16 determining a fraud behaviour likelihood value fraud-v based on the surrounding wireless device delta data swddd and the relative distance between the merchant wireless device 30 and each surrounding wireless device 40a,40b,40c,40d,40e, . . . ,40n. The method advantageously use the information of the received signal strength indicator of the surrounding wireless devices for enhancing the determination of the surrounding wireless device delta data.

Reference is made to FIGS. 4a, 4b, 5a and 5b. When comparing comparing the unique identifiers of the surrounding wireless devices obtained at the first point in time, as illustrated in FIGS. 4a and 4b, with the unique identifiers of the surrounding wireless devices obtained at the second point in time, as illustrated in FIGS. 5a and 5b, it becomes obvious that the surrounding wireless devices “Evil Pro”, “Dark_side” and “Mr_Dealer” occurs both in the first snapshot and the second snapshot. When the received signal strength indicator RSSI of the received radio signals from the surrounding wireless devices “Evil Pro”, “Dark_side” and “Mr_Dealer” are used to determine a relative distance between the merchant wireless device 30 and each surrounding wireless device, the “Evil Pro”, “Dark_side” and “Mr_Dealer” are very close to the merchant wireless device 30, both at the first point in time, and at the second point in time. This is then compared with the surrounding wireless device“Hello_kty”, that is new in the snapshot obtained at second point in time, at “04:22” that is far away from the merchant wireless device 30. This data can then be used for determining a fraud behaviour likelihood value fraud-v based on the surrounding wireless device delta data swddd and the relative distance between the merchant wireless device 30 and each surrounding wireless device, which in this example excludes the the surrounding wireless device“Hello_kty” that is considered to be relatively far away from the merchant wireless device 30.

The third aspect of this disclosure shows a non the second aspect transitory computer readable storage medium 900 having stored thereon instructions for implementing the method according to the second aspect, when executed on a device having processing capabilities.

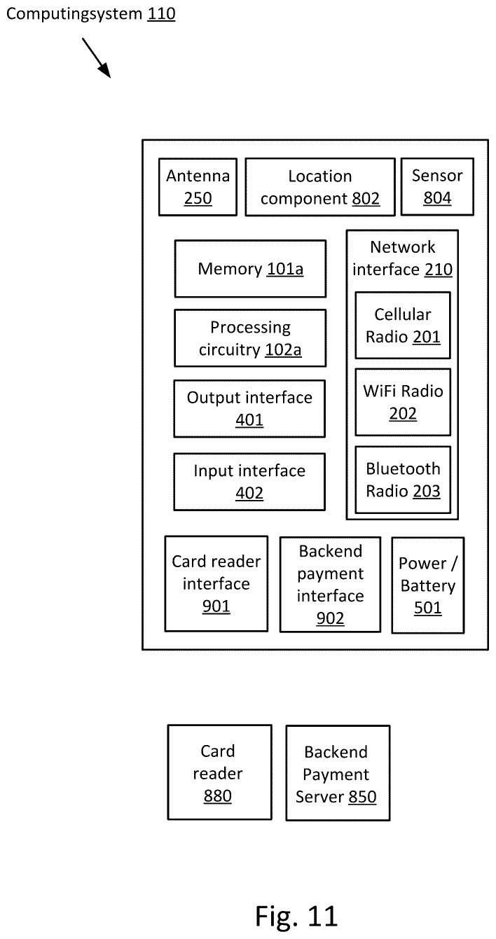

FIG. 11 is a diagram illustrating a computing system 110, which may correspond to either of a merchant wireless device 30 or a server 800. The computing system 110 may be a mobile device such as a smartphone, a tablet computer, a stationary computer, a dedicated card reader terminal, and the like. The computing system 110 comprises a network interface component 210 configured for communication with a network. The network interface component 210 includes a cellular radio interference 201 configured for wireless connection via a wide area wireless communication network, a WiFi radio interference 202 configured for wireless communication via a local area wireless communication network, a Bluetooth radio interference 203 configured for wireless communication via a local area wireless communication network. The wireless connection may be enabled via a local area wireless communication network. The wireless connection may be a standardized wireless local area network such as a Wireless Local Area Network, WLAN, Bluetooth™, ZigBee, Ultra-Wideband, Near Field Communication, NFC, Radio Frequency Identification, RFID, or similar network. The wireless connection may be enabled via a wide area wireless communication network. The wireless connection may be a standardized wide area wireless communication network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network. The network interface component 210 may be configured to interface with a coaxial cable, a fiber optic cable, a digital subscriber line modem, a public switched telephone network modem, an Ethernet device, and/or various other types of wired and/or wireless network communication devices adapted for communication with a communication network.

The computing system 110 may comprise a system bus for interconnecting various components within the computing system 110 and communicating information between the various components. Such components include a Processing circuitry 102a, 102b component which may be one or more processors, micro-controllers, graphics processing units or digital signal processors, and a memory 101a, 101b component which may correspond to a random-access memory, an internal memory component, a read-only memory, or an external or static optical, magnetic, or solid-state memory. The computing system 110 further may comprise an output interface 401 component for displaying information to a user of the computing system 110. The output interface 401 may be a liquid crystal display screen, an organic light emitting diode screen, a Light Emitting Display screen, a plasma display, or a cathode ray tube display. The computing system 110 may also include an input interface 402 component, allowing for a user of the computing system 110, to input information to the computing system 110. Such information could include payment information such as an amount required to complete a transaction, account information, authentication information such as a credential, or identification information. The input interface 402 may include, for example, a keyboard or key pad, whether physical or virtual. The computing system 110 may further comprise a navigation control component, configured to allow a user to navigate along the output interface 401. The navigation control component may be a mouse, a trackball, or other such device. Moreover, if the computing system 110 includes a touch screen, the output interface 401, the input interface 402, and the navigation control may be a single integrated component, such as a capacitive sensor-based touch screen.

The computing system 110 may further include a a card reader interface 901 for enabling interaction with a contactless-enabled card reader terminal 880. The computing system 110 may further include a backend payment interface 902 for enabling payment transactions with a backend payment server 850.

The computing system 110 may further include a location component 802 for determining a location of the computing system 110. The location component 110 may correspond to a GPS transceiver that is in communication with one or more GPS satellites. Alternatively, or in combination, the location component 802 may be configured to determine a location of computing system 110 by using an internet protocol address lookup, or by triangulating a position based on nearby telecommunications towers, wireless access points, or Bluetooth Low Energy beacons. The location component 802 may be further configured to store a user-defined location in the memory 101a, 101b that can be transmitted to a third party for the purpose of identifying a location of the computing system 110. The computing system 110 may also include a sensor 804 component. Sensor component 804 may provide sensor functionality, and may correspond to sensors built into the computing system 110 or sensor peripherals coupled to the computing system 110. The sensor 804 may include any sensory device that captures information related to the computing system 110 or a merchant or customer using the computing system 110 and any actions performed using the computing system 110. The sensor 804 may include camera and imaging components, accelerometers, biometric readers, GPS devices, motion capture devices, and other devices.

The computing system 110 may perform specific operations by the processing circuitry 102a, 102b executing one or more sequences of instructions contained in the memory 101a, 101b. Alternatively, or in combination, hard-wired circuitry may be used in place of or in combination with software instructions to implement the present disclosure. Logic may be encoded in a computer readable medium, which may refer to any medium that participates in providing instructions to the processing circuitry 102a, 102b for execution, including the memory 101a, 101b. The computer readable medium may be tangible and non-transitory. In various implementations, non-volatile media include optical or magnetic disks, volatile media includes dynamic memory, and transmission media includes coaxial cables, copper wire, and fiber optics, including wires that comprise the system bus. Transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Execution of instruction sequences to practice the present disclosure may be performed by the computing system 110. In various other embodiments of the present disclosure, a plurality of computing systems 110 coupled by a communication link to the network, wired or wireless, including telecommunications, mobile, and cellular phone networks may perform instruction sequences to practice the present disclosure in coordination with one another. The computing system 110 may transmit and receive messages, data and one or more data packets, information and instructions, including one or more programs, i.e., application code, through the network interface component 210 and/or at least any of the cellular radio interference 201, the WiFi radio interference 202 and the Bluetooth radio interference 203. Received program code may be executed by the processing circuitry 102a, 102b as received and/or stored in the memory 101a, 101b.

The computing system 110 may further include a power or battery component 501 to electrify the computing system 110.

The computing system 110 may include more or less components than shown in FIG. 11. For example, the components shown in FIG. 11 may be directly coupled to one or more other components in FIG. 11, eliminating a need for the system bus. Furthermore, components shown in FIG. 11 may be shown as being part of a unitary system, but may also be part of a distributed system where the components are separate but coupled and in communication. In general, the components shown in FIG. 11 are shown as examples of components in a computing system 110 capable of performing embodiments disclosed herein. However, a computing system 110 may have more or fewer components and still be capable of performing some embodiments disclosed herein.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A system (100) for detecting fraud behaviour in card payments, the system (100) comprises:
a merchant wireless device (30) configured to receive radio signals to determine presence of surrounding wireless devices (40a,40b,40c,40d,40e, . . . ,40n);
a processing circuitry (102a,102b) operatively connected to the merchant wireless device (30) and configured to:
obtain unique identifiers (ID1,ID2,ID3,ID4,ID5, . . . ,IDn) of surrounding wireless devices (40a,40b,40c,40d,40e, . . . ,40n) based on the received radio signals at the merchant wireless device (30);
in a determination of a first triggering event at a first point in time, store the unique identifiers (ID1,ID2,ID3,ID4,ID5, . . . ,IDn) of each surrounding wireless device (40a,40b,40c,40d,40e, . . . ,40n) obtained at the first point in time;
in a determination of a second triggering event at a second point in time, store the unique identifiers of each surrounding wireless device obtained at the second point in time;
determine a surrounding wireless device delta data (swddd) by comparing the unique identifiers (ID1,ID2,ID3,ID4,ID5, . . . ,IDn) of the surrounding wireless devices (40a,40b,40c,40d,40e, . . . ,40n) obtained at the first point in time with the unique identifiers of the surrounding wireless devices obtained at the second point in time; and
determine a fraud behaviour likelihood value (fraud-v) based on the surrounding wireless device delta data (swddd).

2. The system (100) according to claim 1, wherein the processing circuitry is further configured to continuously obtain unique identifiers of surrounding wireless devices based on the received radio signals at the merchant wireless device (30) and:
in a determination of a third triggering event at a third point in time, store the unique identifiers of each surrounding wireless device obtained at the third point in time; and
determine an updated surrounding wireless device delta data (swddd) by comparing the unique identifiers (ID1,ID2,ID3,ID4,ID5, . . . ,IDn) of the surrounding wireless devices (40a,40b,40c,40d,40e, . . . ,40n) obtained at the first point in time and the unique identifiers of the surrounding wireless devices obtained at the second point in time with the unique identifiers of the surrounding wireless devices obtained at the third point in time.

3. The system (100) according to claim 1, wherein the first triggering event is caused by a first card payment event, and the second triggering event is caused by a second card payment event.

4. The system (100) according to claim 1, wherein the first triggering event is a caused by a timer set to trig an event at a first predetermined time, and the second triggering event is a caused by a timer set to trig an event at a second predetermined time.

5. The system (100) according to according to claim 1, wherein the fraud behaviour likelihood value (fraud-v) is based on the change of obtained unique identifiers of surrounding wireless devices over time.

6. The system (100) according to claim 1, wherein the fraud behaviour likelihood value (fraud-v) is further based on behaviour analysis and/or pattern analysis of meta data, wherein the meta data is at least any of frequency of transaction data, transaction time data, merchant category code data, transaction parameter data, merchant market data, time of day data, location information data, wide area wireless communication network data, and surrounding temperature data.

7. The system (100) according to claim 1, wherein the fraud behaviour likelihood value (fraud-v) is based the change of obtained unique identifiers of surrounding wireless devices over time and
in a determination that the change of obtained unique identifiers of surrounding wireless devices over time is below a predetermined value (pdv), set a high fraud behaviour likelihood value (high-fraud-v); and
in a determination that the change of obtained unique identifiers of surrounding wireless devices over time is above the predetermined value (pdv), set a low fraud behaviour likelihood value (low-fraud-v).

8. A method for detecting fraud behaviour in card payments, the method comprises:
(S1) obtaining unique identifiers (ID1,ID2,ID3,ID4,ID5, . . . ,IDn) of surrounding wireless devices (40a,40b,40c,40d,40e, . . . ,40n) based on received radio signals at a merchant wireless device (30);
(S2) in a determination of a first triggering event at a first point in time, storing the unique identifiers (ID1,ID2,ID3,ID4,ID5, . . . ,IDn) of each surrounding wireless device (40a,40b,40c,40d,40e) obtained at the first point in time;
(S3) in a determination of a second triggering event at a second point in time, storing the unique identifiers of each surrounding wireless device obtained at the second point in time;
(S4) determining a surrounding wireless device delta data (swddd) by comparing the unique identifiers (ID1,ID2,ID3,ID4,ID5, . . . ,IDn) of the surrounding wireless devices (40a,40b,40c,40d,40e, . . . ,40n) obtained at the first point in time with the unique identifiers of the surrounding wireless devices obtained at the second point in time; and
(S7) determining a fraud behaviour likelihood value (fraud-v) based on the surrounding wireless device delta data (swddd).

9. The method (100) according to claim 8 further comprising:
(S5) in a determination of a third triggering event at a third point in time, storing the unique identifiers of each surrounding wireless device obtained at the third point in time; and
(S6) determining an updated surrounding wireless device delta data (swddd) by comparing the unique identifiers (ID1,ID2,ID3,ID4,ID5, . . . ,IDn) of the surrounding wireless devices (40a,40b,40c,40d,40e, . . . ,40n) obtained at the first point in time and the unique identifiers of the surrounding wireless devices obtained at the second point in time with the unique of the surrounding wireless devices obtained at the third point in time.

10. The method (100) according to claim 8 wherein the first triggering event is caused by a first card payment event, and the second triggering event is caused by a second card payment event.

11. The method (100) according to claim 8 wherein the first triggering event is a caused by a timer set to trig an event at a first predetermined time, and the second triggering event is a caused by a timer set to trig an event at a second predetermined time.

12. The method (100) according to claim 8 wherein the fraud behaviour likelihood value (fraud-v) is based on the change of obtained unique identifiers of surrounding wireless devices over time.

13. The method (100) according to claim 12 wherein the fraud behaviour likelihood value is based the change of obtained unique identifiers of surrounding wireless devices over time and
(S8a) in a determination that the change of obtained unique identifiers of surrounding wireless devices over time is below a predetermined value (pdv), setting a high fraud behaviour likelihood value (high-fraud-v); and
(S8b) in a determination that the change of obtained unique identifiers of surrounding wireless devices over time is above the predetermined value (pdv), setting a low fraud behaviour likelihood value (low-fraud-v).

14. The method (100) according to claim 8 further comprising:
(S9) determining a fraud behaviour likelihood value (fraud-v) that is above a predetermined threshold value; and
(S10) terminating further card payment events.

15. The method (100) according to claim 8 further comprising:
(S11) obtaining metadata associated with each unique identifier; and
(S12) determining a fraud behaviour likelihood value (fraud-v) based on the wireless device delta data (wddd) and the metadata associated with each unique identifier.

16. The method (100) according to claim 8 further comprising:
(S13) determining a static surrounding wireless device based on the surrounding wireless device delta data (swddd) in that the unique identifier of the static surrounding wireless device is always present at plural points in time; and
(S14) excluding the static surrounding wireless device in further determination of the surrounding wireless device delta data (swddd).

17. The method (100) according to claim 8 further comprising:
(S15) determining a relative distance between the merchant wireless device (30) and each surrounding wireless device (40a,40b,40c,40d,40e, . . . ,40n) based on a received signal strength indicator (RSSI) of the received radio signals at the merchant wireless device (30); and
(S16) determining a fraud behaviour likelihood value (fraud-v) based on the surrounding wireless device delta data (swddd) and the relative distance between the merchant wireless device (30) and each surrounding wireless device (40a,40b,40c,40d,40e, . . . ,40n).

18. A non-transitory computer readable storage medium (900) having stored thereon instructions for implementing the method according to any one of claims 8-17, when executed on a device having processing capabilities.
